(19) United States
(12) Patent Application Publication
(10) Pub. No.: US 2014/0268001 A1
(43) Pub. Date: Sep. 18, 2014

(54) LIQUID CRYSTAL DISPLAY DEVICE

(71) Applicant: Japan Display Inc., Tokyo (JP)

(72) Inventors: Takato HIRATSUKA, Tokyo (JP); Osamu ITOU, Tokyo (JP); Miharu OTANI, Tokyo (JP); Toshimasa ISHIGAKI, Tokyo (JP); Daisuke SONODA, Tokyo (JP)

(73) Assignee: Japan Display Inc., Tokyo (JP)

(21) Appl. No.: 14/203,879

(22) Filed: Mar. 11, 2014

(30) Foreign Application Priority Data
Mar. 15, 2013 (JP) 2013-053054

(51) Int. Cl. G02F 1/1339

(52) U.S. Cl. CPC G02F 1/13394
USPC 349/160

(57) ABSTRACT

To suppress generation of low temperature impact bubbles and a damage in an electrode, etc. on a wall structure in manufacturing process, the liquid crystal display device according to the present invention includes a first substrate; a second substrate which is provided so as to face the first substrate; a liquid crystal layer which is provided between the first substrate and the second substrate; a wall structure which is formed on the first substrate; a pixel electrode which is provided at least on a side surface of the wall structure; a common electrode which is formed on the first substrate; and a plurality of pixels which include the pixel electrode and the common electrode, in which a high portion is provided at a portion of the wall structure, and the first substrate comes into contact with the second substrate at the high portion.

### CROSS-REFERENCE TO RELATED APPLICATION

The present application claims priority from Japanese application JP 2013-053054 filed on Mar. 15, 2013, the content of which is hereby incorporated by reference into this application.

### BACKGROUND OF THE INVENTION

1. Field of the Invention

The present invention relates to a liquid crystal display device, and particularly to a liquid crystal display device which is driven using a so-called a transverse electric field system.

2. Description of the Related Art

In a liquid crystal display device, liquid crystal are filled in between a TFT substrate on which a pixel electrode, and a thin film transistor (TFT) is formed and a counter substrate on which a color filter, or the like, is formed, and an image is formed by driving and controlling molecules of the liquid crystal using an electric field. In such a liquid crystal display device, a liquid crystal display device which is driven using a system referred to as a transverse electric field system (IPS system) has been widely used in recent years.

The IPS system is a liquid crystal driving system in which liquid crystal molecules are horizontally aligned on a panel surface, and the liquid crystal molecules are rotated in a surface which is parallel to the panel surface by being applied with an electric field (transverse electric field) which is parallel to the panel surface. A liquid crystal display device of the IPS system is also formed with a common electrode on a first substrate side on which a video signal line (drain line), a scanning signal line (gate line), a thin film transistor, and a pixel electrode, or the like, are formed, and a liquid crystal layer is driven by an electric field in the in-plane direction of the first substrate which is generated due to a difference in voltages which are applied to the pixel electrode and the common electrode. In the liquid crystal display device of the IPS system with such a configuration, for example, a linear pixel electrode is arranged in an overlapping manner as an upper layer of a planar common electrode which is formed using a transparent conductive film via an insulating film.

In recent years, in the IPS system, a system has been widely used, in which a wall structure is formed so as to straddle between neighboring pixels of a liquid crystal display device in order to increase an aperture ratio of a liquid crystal display unit, a pixel electrode is formed on a side wall of the wall structure, a common electrode and a counter electrode are further formed on a TFT substrate and a counter substrate, respectively, and an electric field which is parallel to a surface of the substrate is generated, thereby driving a liquid crystal layer.

In addition, a gap between the TFT substrate and the counter substrate in the liquid crystal display device is extremely small, for example, several microns, and it is extremely important to appropriately set the gap between the TFT substrate and the counter substrate when controlling transmission of light using liquid crystal. Therefore, a technology in which the wall structure is caused to also function as a spacer which maintains the gap between the TFT substrate and the counter substrate has been suggested.

Meanwhile, when manufacturing a liquid crystal display device, it is necessary to fill in and seal liquid crystal between substrates. In addition, as a method of filling in liquid crystal, which has been widely used in recent years, there is a method which is referred to as a one drop fill (ODF) process in which a necessary amount of liquid crystal is dropped on one substrate, first, and sealed by the other substrate then, thereby filling in the liquid crystal.

The ODF process has advantages that it requires a smaller manufacturing facility and shorter production time, and it makes mass production of LCDs much easier, than a conventional liquid crystal injection process. On the other hand, when dropping the liquid crystal, or maintaining a gap between the substrates, extremely high precision is required.

When the ODF system is applied to the liquid crystal display device in which a function of a spacer is included in the wall structure, as described above, there is a concern that low temperature impact bubbles may be generated. The low temperature impact bubbles are bubbles which are generated, in particular, under a low-temperature environment of approximately −20° C., among so-called vacuum bubbles which are generated when a negative pressure is generated in a liquid crystal layer, and a gas component such as nitrogen, or the like, which is melted in the liquid crystal layer is flown out, when a shock due to an external force, or the like, is given to a liquid crystal panel, or the like, in which the liquid crystal is filled.

Since the low temperature impact bubbles are hardly re-melted, or vanished, the low temperature impact bubbles become a big factor in causing an occurrence of display unevenness, or the like. The low temperature impact bubbles tend to be generated at a contact portion between a substrate and a spacer, and it is experimentally confirmed that a performance of suppressing a generation of the low temperature impact bubbles is inversely proportional to a contact area between the spacer and the substrate.

The reason why the generation of the low temperature impact bubbles becomes a problem in a liquid crystal display device of the IPS system adopting a wall structure is that there is no space for arranging a sub-spacer of which the height is slightly lower than the main spacer, since the wall structure has uniform height, and is formed on the whole long side of a pixel, thus only a so-called main spacer is arranged in high density. That is, the reason is that a contact area between the substrate and the spacer is increased compared to a case in which the sub-spacer is arranged.

In addition, when a liquid crystal display device is manufactured using the ODF process in a case in which the wall structure also functions as the spacer, the wall structure directly receives a pressure which is generated when bonding a substrate, and there is a concern that the ITO as an electrode, an interlayer insulating film, or the wall structure itself may be damaged.

In JP 2005-157224 A, a technology which defines the thickness of a liquid crystal layer by arranging a wall structure and a support body between substrates in a VA mode liquid crystal display device is disclosed. In addition, also in JP 2009-145865 A and JP 2010-210866 A, technologies for maintaining the gap between substrates using a spacer are disclosed. However, both of the technologies are not sufficient to suppress the low temperature impact bubbles in the IPS system, or prevent a damage of the wall structure, or the like.

### SUMMARY OF THE INVENTION

The present invention has been made by taking the circumstances inconsideration, and an object thereof is to suppress generation of low temperature impact bubbles in a liquid crystal display device having a wall structure. In addition, another object is to prevent a damage of an electrode, or the like, in a substrate at a time of manufacturing in the liquid crystal display device having the wall structure.

In order to solve the problems, a liquid crystal display device in the present invention has the following technical features.

(1) According to an aspect of the present invention, there is provided a liquid crystal display device which includes a first substrate; a second substrate which is provided so as to face the first substrate; a liquid crystal layer which is provided between the first substrate and the second substrate; a wall structure which is formed on the first substrate; a pixel electrode which is provided at least on a side surface of the wall structure; and a common electrode which is formed on the first substrate, in which a plurality of pixels which include the pixel electrode and the common electrode are provided, a high portion is provided at a portion of the wall structure, and the first substrate comes into contact with the second substrate at the high portion.

(2) In the aspect which is described in (1), the portion of the wall structure may be formed right above a TFT unit which is formed on the first substrate.

(3) In the aspect which is described in (1) or (2), the portion of the wall structure may be formed right above a spacer film which is formed on the first substrate.

(4) In the aspect which is described in (1), the pixel electrode may not be formed on a side surface at the portion of the wall structure.

(5) In the aspect which is described in (4), the common electrode may not be formed on the side surface at the portion of the wall structure.

(6) In the aspect which is described in (5), an insulating film which separates the pixel electrode from the common electrode may not be formed on the side surface at the portion of the wall structure.

(7) In the aspect which is described in any one of (1) to (6), the number of pixels may be different from the number of the portions of the wall structures.

(8) In the aspect which is described in any one of (1) to (7), the pixel may have a shape which is bent in the vicinity of a center in a longitudinal direction thereof.

According to each of technical features of the present invention which is described above, it is possible to suppress generation of low temperature impact bubbles in a liquid crystal display device having a wall structure. In addition, it is possible to prevent damage of an electrode, or the like, in a substrate at a time of manufacturing in the liquid crystal display device having the wall structure.

### BRIEF DESCRIPTION OF THE DRAWINGS

FIG. 1 is a cross-sectional view which schematically illustrates a pixel configuration in a liquid crystal display device according to an embodiment 1 of the present invention.

FIG. 2 is a plan view which schematically illustrates the pixel configuration in the liquid crystal display device according to the embodiment 1 of the present invention.

FIG. 3 is a diagram which illustrates a section which is taken along line III-III in FIG. 2.

FIG. 4 is a diagram which illustrates a section in a modification example of the liquid crystal display device according to the embodiment 1 of the present invention.

FIG. 5 is a diagram which illustrates a section in another modification example of the liquid crystal display device according to the embodiment 1 of the present invention.

FIG. 6 is a plan view which schematically illustrates a configuration of three neighboring pixels.

FIG. 7 is a cross-sectional view which schematically illustrates a pixel configuration in a liquid crystal display device according to an embodiment 2 of the present invention.

FIG. 8 is a plan view which schematically illustrates a pixel configuration in a liquid crystal display device according to an embodiment 3 of the present invention.

### DETAILED DESCRIPTION OF THE INVENTION

### Embodiment 1

Hereinafter, a liquid crystal display device according to an embodiment 1 of the present invention will be described in detail referring to FIGS. 1 to 6.

FIG. 1 is a cross-sectional view which schematically illustrates a pixel configuration of a liquid crystal display device according to the embodiment, and FIG. 2 is a plan view which schematically illustrates the pixel configuration of the liquid crystal display device according to the embodiment.

As illustrated in FIG. 1, the liquid crystal display device has a structure in which a TFT substrate 2 which is a first substrate, a color filter (CF) substrate 1 which is a second substrate provided so as to face the TFT substrate 2, and a liquid crystal layer 6 which is provided between the TFT substrate 2 and the CF substrate 1 are laminated. A wall structure 4 and a sub-wall structure 12 which is lower than the wall structure 4 are formed on the TFT substrate 2, and the TFT substrate includes a pixel electrode 8 which is a first electrode provided at least on a side surface of the wall structure 4, and a common electrode 5 which is formed on the TFT substrate 2 and covers at least the sub-wall structure 12. According to the embodiment, the pixel electrode 8 is provided so as to cover the side surface of the wall structure 4 and a region between the wall structure 4 and the sub-wall structure 12, and an illustrated structure of a section thereof has approximately an L shape. For this reason, the sub-wall structure 12 is not covered with the pixel electrode 8 when viewed planarly. According to the embodiment, the common electrode 5 is provided so as to cover the entire surface of the TFT substrate 2, however, the common electrode just has to cover the sub-wall structure 12. That is, when viewed planarly, the common electrode 5 is not covered with the pixel electrode 8 in a region in which the sub-wall structure 12 is arranged. The pixel electrode 8 is separated from the common electrode 5 therebetween by an insulating film 13. In addition, in a region between the wall structure 4 and the sub-wall structure 12, an insulating film 7 is provided so as to cover the pixel electrode 8. The insulating film 7 may cover the sub-wall structure 12. In addition, an alignment film is not illustrated in the figure.

The CF substrate 1 includes a filter for a red color, a filter for a green color, and a filter for a blue color, and takes a role of applying a color to light which is irradiated from a back light (not shown) and penetrates the liquid crystal layer 6. In addition, as will be described later, a black matrix BM is formed at a position which partitions pixels on the CF substrate, and the CF substrate further includes a counter electrode 9, and an overcoat layer OC.

The liquid crystal display device has a structure in which a predetermined gap is provided between the CF substrate 1 and the TFT substrate 2 which face each other in this manner, and the liquid crystal layer 6 is formed by filling liquid crystal in the gap. The liquid crystal layer 6 is driven by an electric field which is generated between the pixel electrode 8 and the common electrode which is arranged on the sub-wall structure 12. That is, a region which is sandwiched between neighboring wall structures 4, and in which the liquid crystal is driven by the pixel electrode 8 applied with an equipotential and the common electrode 5 becomes one pixel 10. FIG. 1 illustrates a section of one pixel of the liquid crystal display device.

In addition, the wall structure 4 is arranged at a shading area which is shaded by the black matrix layer BM, and a drain signal line 14 is arranged at a lower portion of the wall structure 4. In addition, a gate signal line which applies a scanning signal (not shown) is arranged in a matrix on the TFT substrate 2, in addition to the drain signal line 14, and a rectangular pixel 10 is formed by a set of the gate signal line and the drain signal line 14. On the TFT substrate 2, a switching element such as a TFT, and other circuit elements are arranged in addition to these, however, these do not appear on the section which is illustrated in FIG. 1.

As a material of the CF substrate 1 and the TFT substrate 2, for example, a glass substrate is commonly used, however, a transparent resin substrate with an insulating property may be used. In addition, the pixel electrode 8 and the common electrode 5 are formed using a method in which an electrode film is formed using a sputtering method, using a transparent conductive material such as Indium-Tin-Oxide (ITO), for example, and etching is selectively performed using a photolithography method, or the like. Alternatively, various metal oxide materials such as Indium-Zinc-Oxide (InZnO), for example, may be used in place of ITO. The wall structure 4 and the sub-wall structure 12 are formed using, for example, a photosensitive resin material, and are formed using a known photolithography method, or the like.

In addition, the wall structure 4 is formed in a shading region which partitions a boundary of the pixel 10 and a neighboring pixel 11, and a peripheral circuit region of a display unit which is not an effective display region of the liquid crystal display device. Here, the shading region is a region which is formed on the CF substrate 1, and is shaded without contributing to a display, and according to the embodiment, the shading region is formed by forming the black matrix layer BM which is formed using a photosensitive resin, or the like. The shading region may be formed, for example, by causing the TFT, gate signal wiring, the drain signal line 14, or the like, to have an ability of shading, in addition to the black matrix layer BM. In addition, the pixel electrode 8 is formed at least on the side surface of the wall structure 4 in order to apply a uniform transverse electric field to the liquid crystal layer 6, as described above, however, it is preferable that the pixel electrode be not formed on the upper part of the wall structure 4. The reason is to avoid a short circuit of the neighboring pixel 11 with respect to the pixel electrode 8. Accordingly, when forming the pixel electrode 8, it is preferable to use an appropriate mask, or form a film for separating in advance on the upper part of the wall structure 4, and then remove the film after forming the electrode film. The insulating film 7 is a film for preventing an unnecessary short circuit between the common electrode 5 and the pixel electrode 8, or between these electrodes and the other circuit elements, and is formed using a material such as SiN, and using a well-known CVD method, or the like.

With the above described configuration, an electric field which has a component parallel to the CF substrate 1 and the TFT substrate 2, and having a strength according to a voltage which is applied to the pixel electrode 8 is generated between a portion of the pixel electrode 8, particularly a portion which is formed on the side surface of the wall structure 4 and a portion of the common electrode 5 which covers the sub-wall structure 12, and the liquid crystal molecule in the liquid crystal layer 6 is driven so that an aligning direction thereof is rotated in the horizontal plane using the electric field. Such a liquid crystal display device is referred to as an IPS system, or a transverse electric field system in general, and is known as a system which can perform a display of a wide viewing angle. In addition, the liquid crystal display device according to the embodiment is assumed to perform a display of normally black in which light transmittance is minimized (display of black) when the electric field is not applied to the liquid crystal layer 6, and the light transmittance is increased by applying the electric field.

FIG. 2 is a plan view which schematically illustrates the pixel configuration in the liquid crystal display device according to the embodiment 1 of the present invention. As illustrated in the figure, the pixel 10 has an approximately rectangular shape, and is formed by a region which is set by the gate signal line and the drain signal line, though they are not shown. In addition, the figure illustrates a structure which is formed on the TFT substrate 2, and the insulating films 7 and 13 are not shown.

In addition, the wall structure 4 according to the embodiment is sequentially formed so as to sandwich the pixel on both end sides on the left and right of the pixel, and a portion of the wall structure 4 is formed so as to cover a TFT unit 17. Here, the TFT unit 17 is a part of a region of the TFT substrate 2, and is a region in which layers forming the TFT, that is, a source electrode, a drain electrode, a gate electrode, a gate insulating film, and a semiconductor layer are formed, and the TFT unit 17 has a shape in which the front surface of the TFT substrate 2 is swollen as much as the thickness of each layer which configures the TFT. In addition, a through hole 15 has a structure of connecting the pixel electrode 8 to the drain electrode of the TFT (or source electrode) which is formed on the TFT unit 17. Note that, the previously illustrated FIG. 1 is a diagram which illustrates a section which is taken along line I-I in FIG. 2.

FIG. 3 is a diagram which illustrates a section which is taken along line III-III in FIG. 2. As illustrated in the figure, the wall structure 4 which is formed right above the TFT unit 17 becomes partially high as much as the thickness of the TFT unit 17. In addition, the wall structure 4 comes into contact with the overcoat layer OC of the CF substrate 1 at the portion which becomes partially high, and defines the width of a gap between the CF substrate 1 and the TFT substrate 2. That is, almost the whole portion of the wall structure 4 except for the portion right above the TFT unit 17 does not come into contact with the CF substrate 1, and has a gap as much as the thickness of the TFT unit 17.

With this structure, a distance of the CF substrate 1 from the TFT substrate 2 is defined when the CF substrate comes into contact with a small area right above the TFT unit 17, and bending of the surface in a normal direction is allowed in almost the whole remaining region. For this reason, even when a volume of the liquid crystal layer 6 contracts due to a low temperature, the change in volume is absorbed due to the bending of the CF substrate 1, and the generation of the low temperature impact bubbles is prevented without a remarkable decompression of the liquid crystal layer 6.

In addition, as illustrated in FIG. 3, the pixel electrode 8 is not formed on the side surface of the wall structure 4 which is formed right above the TFT unit 17. This is because the TFT unit 17 is formed outside an aperture which transmits light, and the portion of the wall structure 4 which is formed right above the TFT unit is also formed outside the aperture, and accordingly, the portion does not contribute to a display even when the pixel electrode 8 is provided, and rather than that, a disturbance of the electric field which is caused when providing the pixel electrode 8 at an unnecessary portion can be prevented by not providing the pixel electrode 8.

Moreover, an effect of the above described structure can be obtained if a distance between the TFT substrate 2 and the CF substrate 1 is defined when only a portion of the wall structure 4 which is formed on the TFT substrate 2 comes into contact with the CF substrate 1, and a specific structure thereof is not limited to the structure in the embodiment which is described above. The structure in which only a portion of the wall structure 4 comes into contact with the CF substrate 1 may be any of a structure in which a support body as a protrusion is created at a portion of atop face of the wall structure 4, and a structure in which a support body as a protrusion is created on the side of the CF substrate 1, in addition to the structure in which a portion of the wall structure 4 is increased in height by providing a structure having an appropriate thickness at the lower part of the wall structure 4, as exemplified in the embodiment.

FIG. 4 is a diagram which illustrates a section in a modification example of the liquid crystal display device according to the embodiment. The figure corresponds to FIG. 3, and illustrates a section which is taken along line IIII-III in FIG. 2, similarly to FIG. 3. In the modification example, the common electrode 5 is not formed on the side surface and a top face of the wall structure 4 which is provided right above the TFT unit 17. The reason is as follows. That is, when manufacturing a liquid crystal display device using the ODF process, a pressure at a time of bonding the CF substrate 1 to the TFT substrate 2 is concentrated on a portion of the wall structure 4 which is provided right above the TFT unit 17 with which the CF substrate 1 and the TFT substrate 2 come into contact, and the pressure works as a force compressing the wall structure 4 in the perpendicular direction. At this time, since the compressing force of a film in the in-plane direction works on the film which is formed on the side surface of the wall structure 4 too. So when an adhesive force of the film with respect to the wall structure 4 is weak, or the film is weak in transforming that the film shows brittleness and hardness in elastic transformation, etc., there is a concern that the film may be broken, may be separated from the wall structure 4, and may be mixed into the liquid crystal layer 6 as a foreign material. In addition, according to the embodiment, as described above, the common electrode 5 is metal oxide such as ITO, and is weak in transforming, the common electrode is set in advance so as not to be formed on the side surface of the wall structure 4 which is provided right above the TFT unit 17.

FIG. 5 is a diagram which illustrates a section in another modification example of the liquid crystal display device according to the embodiment. The figure also corresponds to FIG. 3, and illustrates a section which is taken along line in FIG. 2, similarly to FIG. 3. In the modification example, in addition to the common electrode 5, the insulating film 13 which is an inorganic film such as SiN, is also not formed on the side surface of the wall structure 4 which is provided right above the TFT unit 17, and damages and separation of these films are prevented when manufacturing the liquid crystal display device using the ODF process.

Meanwhile, in the above description, a high portion (that is, portion located right above TFT unit 17) is provided at a portion of the wall structure 4 in a ratio of one portion for one pixel. However, this invention is not limited to this, and the number of high portions at a portion of the wall structure 4 and arrangements thereof are not necessarily one-to-one with respect to the pixel, for example, it may be a ratio of one portion with respect to a plurality of pixels, or the like, and for example, one high portion of the wall structure 4 at a portion thereof may be provided with respect to the plurality of pixels. FIG. 6 is a plan view which schematically illustrates a configuration of three pixels which are adjacent. In an example in the figure, the wall structure 4 is arranged right above the TFT unit 17 (not shown) only at a position which is denoted by A in the figure with respect to neighboring three pixels, and a high portion is provided at a portion of the wall structure 4 in a ratio of one portion for three pixels. The number of high portions which is provided at a portion of the wall structure 4 and arrangements thereof are arbitrary, however, the larger the number of the portions is, and thus the more densely the portions are arranged, the bigger the risk of generation of low temperature impact bubbles becomes, because the gap between the CF substrate 1 and the TFT substrate 2 becomes stationary. On the other hand, the smaller the number of the portions is, and thus the more sparsely the portions are arranged, the bigger the risk of occurrence of unevenness in a display image becomes, because the CF substrate 1 (or TFT substrate 2) becomes to bent easily and the thickness of the liquid crystal layer 6 becomes to change easily. Accordingly, the number of high portions at a portion of the wall structure 4 and arrangements thereof should be selected so as to be optimal according to a product to be manufactured. In addition, regarding the arrangement, the high portion at a portion of the wall structure 4 may be regularly arranged (for example, arrangement of lattice shape), or may be irregularly arranged.

In the above described liquid crystal display device according to the embodiment, the high portion is formed at a portion of the wall structure 4, and the portion comes into contact with the CF substrate 1 by forming a portion of the wall structure 4 right above the TFT unit 17, however, a method of forming the high portion at a portion of the wall structure 4 is not limited to this.

### Embodiment 2

FIG. 7 is a cross-sectional view which schematically illustrates a pixel configuration in a liquid crystal display device according to an embodiment 2 of the present invention. The figure corresponds to FIG. 1 according to the embodiment 1. In addition, since the liquid crystal display device is the same as the liquid crystal display device according to the embodiment 1, except for a different method of forming a high portion at a portion of the wall structure 4, the same reference numbers are given in common portions, and redundant descriptions will be omitted.

In the figure, wall structures 4 which are located on the right and left of a pixel 10 are respectively illustrated, and in the wall structure 4 which is located on the right side of the pixel 10, a section of a high portion which is formed at a portion thereof is illustrated. According to the embodiment, a spacer film 16 which is a film having a predetermined thickness at the lower part of the wall structure 4 is formed in advance, and a high portion is formed right above the spacer film 16 by forming the wall structure 4 so as to straddle the spacer film 16, differently from the previous embodiment in which the high portion of the wall structure 4 is formed by forming the wall structure 4 right above the TFT unit. A material or a manufacturing method of the spacer film 16 may be any material or any method, and is not particularly limited, however, when creating the spacer film 16 at the same time when creating the sub-wall structure 12, an increase in manufacturing cost can be suppressed, since an additional process for creating the spacer film 16 is not necessary. In such a case, a material of the sub-wall structure 12 and a material of the spacer film 16 are the same.

In addition, the embodiment does not prevent the high portion from being formed by forming the wall structure 4 right above the TFT unit 17, and the high portion of the wall structure 4 which is formed using the spacer film 16 and the high portion of the wall structure 4 which is formed using the TFT unit 17 may be mixed together. Moreover, the spacer film 16 may be further provided right above the TFT unit 17 in order to adjust the height of the high portion of the wall structure 4.

### Embodiment 3

FIG. 8 is a plan view which schematically illustrates a pixel configuration of a liquid crystal display device according to an embodiment 3 of the present invention. The figure corresponds to FIG. 2 in the embodiment 1. In addition, since a liquid crystal display device is the same as the liquid crystal display device according to the embodiment 1, except for a difference in a planar shape in the whole pixel 10, common portions will be given the same reference numbers, and redundant descriptions thereof will be omitted.

As illustrated in the figure, the pixel 10 in the liquid crystal display device is bent in the vicinity of a center in the longitudinal direction thereof, and regions D1 and D2 are included so that angles of a wall structure 4 and a sub-wall structure 12 are opposite to each other with respect to the arranging direction (vertical direction in figure) in the longitudinal direction of the pixel 10. For this reason, a pixel electrode 8 which is formed on the side surface of the wall structure 4, and a portion of a common electrode 5 which covers the sub-wall structure 12 are also arranged at an angle of being opposite to each other in the regions D1 and D2.

The illustrated configuration is a configuration which is known as a so-called multi domain structure, and is a configuration which makes a rotating angle of a liquid crystal in each region symmetric to each other in the reverse direction, by making electric fields which are generated in the regions D1 and D2 symmetric in the reverse direction. In this manner, unintended coloring which is generated when the liquid crystal display device is viewed from a specific direction is offset each other in the regions D1 and D2, and a high quality image display is performed in an wide viewing angle.

### Practical Examples

A liquid crystal display device has been manufactured based on the embodiment 1. At this time, the number of portions and arrangements of the wall structure 4 which is formed right above the TFT unit 17 has been set so that the ratio of a contact area becomes 0.054% when defining the ratio of the contact area between the CF substrate 1 and the TFT substrate 2 using an area of a portion at which the CF substrate 1 and the TFT substrate 2 come into contact with each other (that is, portion of wall structure 4 which is formed right above TFT unit 17) with respect to an area of an image display region.

The following test of low temperature impact bubbles has been performed with respect to the liquid crystal display device in order to evaluate a resistance to a generation of the low temperature impact bubbles. In addition, in order to evaluate a maintaining performance of a size of a gap between the CF substrate 1 and the TFT substrate 2, the following repeated push test has been performed.

### <Test for Low Temperature Impact Bubble>

A steel ball of a diameter 11 mm is subject to a free-fall from a distance of 10 cm in an environment of −20° C., and is collided with a liquid crystal display device, after keeping the liquid crystal display device for 24 hours in a temperature of −20° C., and then whether or not the low temperature impact bubble is generated is visually evaluated.

### <Repetitive Depression Test>

A load of 105 N is repeatedly loaded at a speed of 200 N/s for five times with respect to a range of 10 mm of a diameter on the surface of a liquid crystal display device 100, and then whether or not an oppression trace is generated after 1 minute of unloading is visually evaluated.

As a result of the test of low temperature impact bubbles and the repeated push test, it is understood that a liquid crystal display device in which there is no generation of the low temperature impact bubble and the oppression trace, which has a resistance to the low temperature impact bubbles, and in which the size of the gap between the CF substrate 1 and the TFT substrate 2 is maintained without a problem can be obtained.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device comprising:
a first substrate;
a second substrate which is provided so as to face the first substrate;
a liquid crystal layer which is provided between the first substrate and the second substrate;
a wall structure which is formed on the first substrate;
a pixel electrode which is provided at least on a side surface of the wall structure; and
a common electrode which is formed on the first substrate,
wherein a plurality of pixels which include the pixel electrode and the common electrode are provided,
wherein a high portion is provided at a portion of the wall structure, and
wherein the first substrate comes into contact with the second substrate at the high portion.

2. The liquid crystal display device according to claim 1,
wherein the portion of the wall structure is formed right above a TFT unit which is formed on the first substrate.

3. The liquid crystal display device according to claim 1,
wherein the portion of the wall structure is formed right above a spacer film which is formed on the first substrate.

4. The liquid crystal display device according to claim 1,
wherein the pixel electrode is not formed on a side surface at the portion of the wall structure.

5. The liquid crystal display device according to claim 4,
wherein the common electrode is not formed on the side surface at the portion of the wall structure.

6. The liquid crystal display device according to claim 5,
wherein an insulating film which separates the pixel electrode from the common electrode is not formed on the side surface at the portion of the wall structure.

7. The liquid crystal display device according to claim 1,
wherein the number of pixels is different from the number of the portion of the wall structures.

8. The liquid crystal display device according to claim 1,
wherein the pixel has a shape which is bent in the vicinity of a center in a longitudinal direction thereof.
